(19) United States
(12) Patent Application Publication
(10) Pub. No.: US 2025/0187414 A1
(43) Pub. Date: Jun. 12, 2025

(54) WINDOW GLASS FOR VEHICLE

(71) Applicant: AGC Inc., Tokyo (JP)

(72) Inventor: Shigemitsu IGEI, Tokyo (JP)

(73) Assignee: AGC Inc., Tokyo (JP)

(21) Appl. No.: 18/975,534

(22) Filed: Dec. 10, 2024

(30) Foreign Application Priority Data
Dec. 11, 2023 (JP) 2023-208240

(51) Int. Cl. B60J 10/76; B60J 10/15; B60J 10/24; B60J 10/25

(52) U.S. Cl. CPC B60J 10/76; B60J 10/15; B60J 10/24; B60J 10/25

(57) ABSTRACT

A window glass for vehicle according to an aspect of the present disclosure includes: a fixed glass fixed to a vehicle; a movable glass configured to be fitted into an opening of the fixed glass; support members; and a seal member configured to seal a gap between the movable glass and the fixed glass in which: a frame is provided on the peripheral edge of the movable glass; the frame includes a groove into which the seal member is fitted; the seal member includes a deformable cylindrical part and an engaging part extending from the deformable cylindrical part toward the groove; the engaging part is formed by a hard elastic body, and the deformable cylindrical part is formed by a soft elastic body; and a height of a mouth of the groove is larger than a thickness of a root of the engaging part.

### INCORPORATION BY REFERENCE

This application is based upon and claims the benefit of priority from Japanese patent application No. 2023-208240, filed on Dec. 11, 2023, the disclosure of which is incorporated herein in its entirety by reference.

### BACKGROUND

The present disclosure relates to a window glass for vehicle.

A technique in which a part of a fixed glass fixed to a vehicle is hollowed out to form an opening therein, and a movable glass is fitted into the opening has been known. In some cases, a seal member for sealing a gap between the fixed glass and the movable glass is provided in order to prevent rainwater or the like from entering the inside of the vehicle.

Patent Literature 1 discloses a technique in which a movable glass is fitted into an opening provided in a side window glass (fixed glass) of a minivan, and a gap between the fixed glass and the movable glass is sealed by using two types of seal members, i.e., a main seal member and a sub seal member.
Patent Literature 1: International Patent Publication No. WO2017/018189

### SUMMARY

In the technique disclosed in Patent Literature 1, rainwater or the like is prevented from entering the inside of the vehicle through a gap between the movable glass and the fixed glass by using two types of seal members. However, there is a problem that the use of two types of seal members complicates the structure and increases the manufacturing cost.

In view of the above-described problem, an object of the present disclosure is to provide a window glass for vehicle of which it is possible to reduce the manufacturing cost of the seal member which is used to prevent rainwater or the like from entering the inside of the vehicle.

A window glass for vehicle according to an aspect of the present disclosure comprises:
a fixed glass with an opening formed therein configured to be fixed to a vehicle;
a movable glass configured to be fitted into the opening in the fixed glass;
a support member configured to slidably support the movable glass relative to the fixed glass; and
a seal member configured to seal a gap between a peripheral edge of the movable glass and a peripheral edge of the opening in the fixed glass when the movable glass is fitted into the opening in the fixed glass, wherein
a frame is provided on the peripheral edge of the movable glass, the frame includes a groove into which the seal member is fitted,
the seal member includes a deformable cylindrical part deformable at the time of sealing, and an engaging part extending from the deformable cylindrical part toward a bottom surface of the groove,
the engaging part is formed by using a hard elastic body, and the deformable cylindrical part is formed by using a soft elastic body, and
a height of a mouth of the groove is larger than a thickness of a root of the engaging part.

According to the present disclosure, it is possible to reduce the manufacturing cost of a seal member which is used to prevent rainwater or the like from entering the inside of a vehicle.

The above and other objects, features and advantages of the present disclosure will become more fully understood from the detailed description given hereinbelow and the accompanying drawings.

### BRIEF DESCRIPTION OF DRAWINGS

FIG. 1 shows an example of a vehicle including a window glass for vehicle according to an embodiment;

FIG. 2 shows a configuration of a window glass for vehicle according to an embodiment;

FIG. 3 is an enlarged cross-sectional view of a part a window glass for vehicle according to an embodiment;

FIG. 4 is a cross-sectional view of a seal member before it is fitted into a frame;

FIG. 5 is a cross-sectional view of the seal member in a state where it is fitted into the frame; and

FIG. 6 shows an example of a drain cover.

### DESCRIPTION OF EMBODIMENTS

Embodiments according to the present disclosure will be described hereinafter with reference to the drawings. Note that for ease of understanding, the scale of each part in the drawings may differ from the actual scale. Regarding the directions such as parallel, right angle, orthogonal, horizontal, vertical, up/down, and left/right, deviations to such a degree that the effect of embodiments is not impaired are allowed. The shapes of corners are not limited to right angles, but they may be rounded in arcuate shapes. The parallel, right angle, orthogonal, horizontal, and vertical may include roughly parallel, roughly right angle, roughly orthogonal, roughly horizontal, and roughly vertical, respectively. In the specification of the present application, the term “peripheral edge” refers to an area having a certain width from an outer edge toward a center or from an inner edge toward an outer side. Further, in this specification, the term “roughly” means a state where the shape is the same and/or the size is the same to the human eyes.

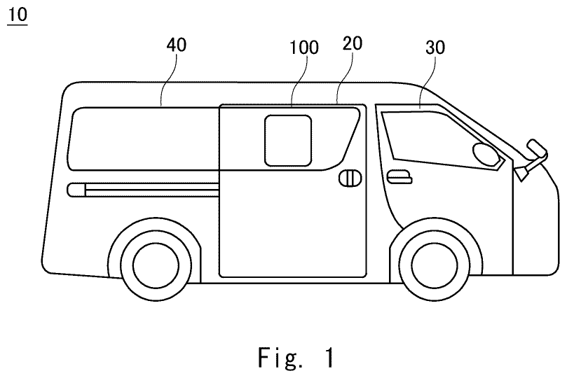

FIG. 1 shows an example of a vehicle 10 including a window glass for vehicle 100 according to an embodiment. The vehicle 10 is a minivan, and includes a slide door 20 and a side door 30 on a side thereof. The window glass for vehicle 100 is provided in the slide door 20. In this embodiment, the front/rear, the right/left, and the up/down correspond to the front/rear, the right/left, and the up/down, respectively, of the vehicle 10.

As shown in FIG. 1, the vehicle 10 includes a front opening (not shown) in a front part of each of the left and right sides of the vehicle. A side door 30 is attached to each of the front openings in such a manner that it can be opened and closed. A central opening (not shown) is provided on each of the left and right sides of the central part of the vehicle 10. A slide door 20 is attached to each of the central openings in such a manner that it can be opened and closed in the front/rear direction of the vehicle 10. The example shown in FIG. 1 shows a state where the slide door 20 is closed. The slide door 20 is attached to the vehicle so that it can be slid toward the rear of the vehicle. Therefore, the slide door 20 can be opened by sliding the slide door 20 toward the rear of the vehicle.

A window glass for vehicle 100 is attached to the slide door 20. For example, as shown in FIG. 1, the window glass for vehicle 100 may be designed so that it is continuous with a window glass 40 provided in the rear part of the vehicle 10.

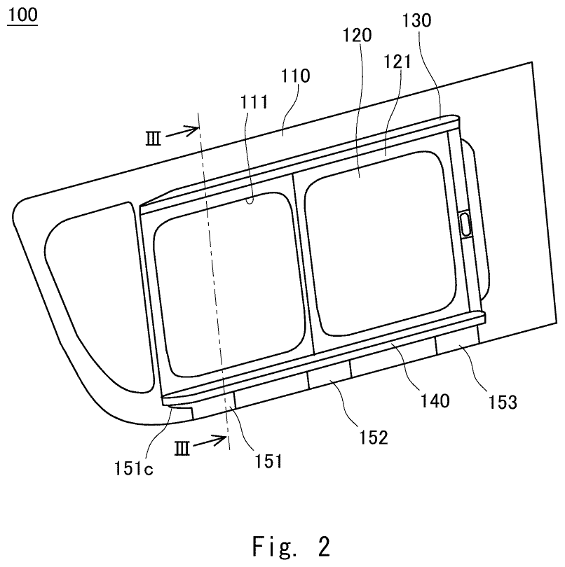

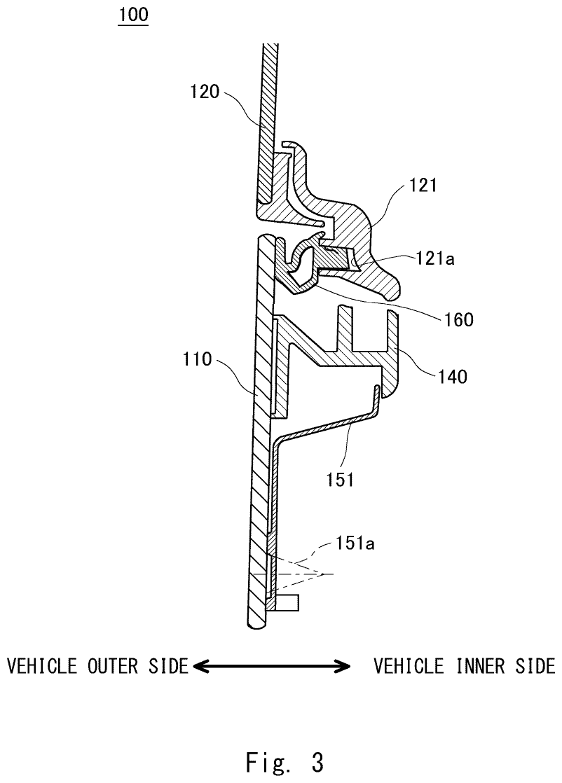

FIG. 2 shows a window glass for vehicle 100 provided on the right side of a vehicle 10 as viewed from the inside of the vehicle. FIG. 3 is a cross-sectional view of a part of the window glass for vehicle 100. FIG. 3 is an enlarged cross-sectional view of a support member 140 and an area therearound taken along a line III-III shown in FIG. 2. The window glass for vehicle 100 includes a fixed glass 110, a movable glass 120, support members 130 and 140, and a seal member 160. Further, the window glass for vehicle 100 may include drain covers 151, 152 and 153.

The fixed glass 110 is a rectangular glass plate and is fixed to the slide door 20. As shown in FIG. 2, the fixed glass 110 may have, for example, a horizontally long shape. A small window (opening) 111 is provided in the fixed glass 110. The small window 111 is a rectangular opening with rounded corners, and its upper and lower sides are roughly horizontal.

The movable glass 120 can be engaged into the window 111 provided in the fixed glass 110, and is movable with respect to the fixed glass 110 and the slide door 20. As shown in FIG. 2, a frame 121 is provided on the peripheral edge of the movable glass 120. The movable glass 120 is supported by the support members 130 and 140. The support member 130 is a member attached to the fixed glass 110 above the upper side of the window 111. The support member 140 is a member attached to the fixed glass 110 below the lower side of the window 111. The frame 121 is fitted into the support members 130 and 140. The support members 130 and 140 extend roughly horizontally and support the movable glass 120 in such a manner that the movable glass 120 is horizontally slidable therebetween. In other words, the support members 130 and 140 are rails that support the movable glass 120 so that the movable glass 120 is horizontally slidable therebetween. FIG. 2 shows a state in which the movable glass 120 is displaced from the window 111, i.e., the window 111 is opened.

As shown in FIG. 3, the window glass for vehicle 100 includes the seal member 160 for sealing a gap between the peripheral edge of the small window 111 and the peripheral edge of the movable glass 120 when the small window 111 is closed. The seal member 160 is an annular member formed by using an elastic body. The seal member 160 is fitted into a groove 121a provided in the frame 121 and thereby fixed to the movable glass 120. The groove 121a is provided in the surface of the frame 121 on the vehicle outer side along the entire peripheral edge of the frame 121 which makes a complete loop. The seal member 160 slides with respect to the fixed glass 110 and the slide door 20 together with the movable glass 120.

The drain covers 151, 152 and 153 are attached to the lower part of the support member 140, and drains rainwater or the like that has entered the inside of the vehicle through a gap between the small window 111 and the movable glass 120 to the outside of the vehicle. Although a case in which three drain covers 151, 152 and 153 are provided is shown in the example shown in FIG. 2, the number of drain covers is not limited to any particular number and can be changed as desired.

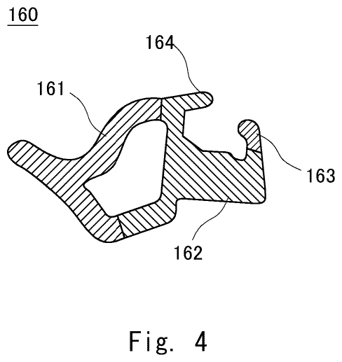

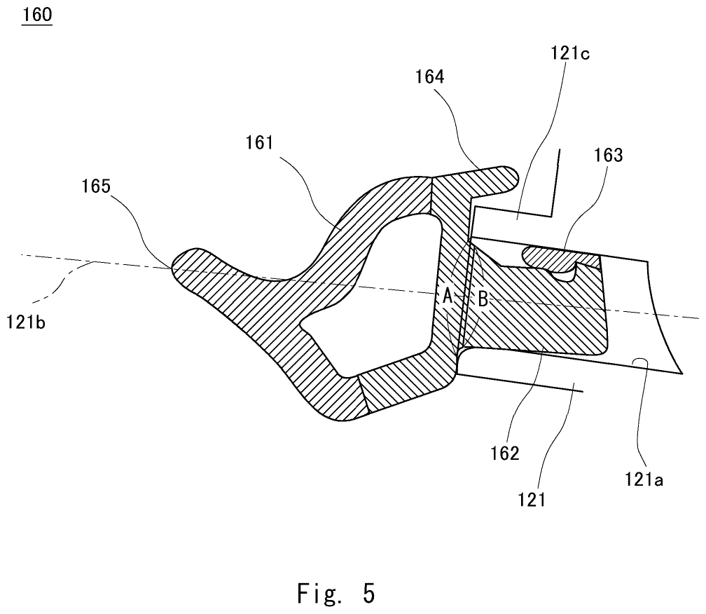

Next, the structure of the seal member 160 will be described in detail with reference to FIGS. 4 and 5. FIG. 4 is a cross-sectional view of the seal member 160 before it is fitted into the frame 121. FIG. 5 is a cross-sectional view of the seal member 160 in a state where it is fitted into the frame 121. As shown in FIG. 4, the seal member 160 includes a deformable cylindrical part 161 and an engaging part 162. Further, the seal member 160 may include a protrusion 163, a wall-like part 164, and the like.

When the movable glass 120 is fitted into the small window 111, the deformable cylindrical part 161 and the engaging part 162 are sandwiched between the frame 121 and the fixed glass 110 and thereby deformed, so that they seal a gap between the frame 121 and the fixed glass 110. The deformable cylindrical part 161 is formed by using a soft elastic body. The specific gravity of the soft elastic body is preferably 0.2 or larger and 0.7 or smaller, may be 0.3 or larger and 0.6 or smaller, or may be 0.4 or larger and 0.5 or smaller. The Shore A hardness of the soft elastic body is preferably 20 or higher and 50 or lower, may be 25 or higher and 45 or lower, or may be 30 or higher and 40 or lower. Note that the Shore A hardness is measured according to JIS K 6253 (2012). The soft elastic body is, for example, a material obtained by adding a foaming agent to ethylene propylene rubber (EPDM) or silicone rubber.

As shown in FIG. 5, the engaging part 162 is engaged into the groove 121a of the frame 121. In other words, the engaging part 162 extends from the deformable cylindrical part 161 toward the bottom of the groove 121a. The engaging part 162 is formed by using a hard elastic body. The hard elastic body has a larger specific gravity and a larger Shore A hardness than those of the soft elastic body. The specific gravity of the hard elastic body is preferably 0.7 or higher and 1.2 or lower, may be 0.8 or higher and 1.1 or lower, or may be 0.9 or higher and 1.0 or lower. The Shore A hardness of the hard elastic body is preferably 50 or higher and 90 or lower, may be 55 or higher and 85 or lower, or may be 60 or higher and 80 or lower. The hard elastic body is, for example, ethylene propylene rubber or silicone rubber.

As shown in FIG. 5, the height A of the mouth of the groove 121a is larger than the thickness B of the root, i.e., base part, of the engaging part 162. In other words, the groove 121a and the engaging part 162 are designed so that a gap is formed between the edge of the groove 121a and the root of the engaging part 162. Since the engaging part 162 is formed by using a hard elastic body, it hardly deforms when it is engaged into the groove 121a. Therefore, in the case of a design in which there is no gap between the edge of the groove 121a and the root of the engaging part 162, it may be difficult to fit, i.e., insert, the engaging part 162 to a predetermined position in the groove 121a due to variations in their sizes or the like.

In contrast to this, the window glass for vehicle 100 according to this embodiment is designed so that a gap is formed between the edge of the groove 121a and the root of the engaging part 162. Therefore, the engaging part 162 can be fitted, i.e., inserted, to a predetermined position in the groove 121a. Therefore, it is possible to prevent the deformable cylindrical part 161 from being displaced which would otherwise be caused when the engaging part 162 is not fitted in the predetermined position in the groove 121a, and thereby to ensure the sealing property of the deformable cylindrical part 161.

A protrusion 163 is preferably provided at the tip of the engaging part 162 in the direction in which the engaging part 162 extends (hereinafter simply referred to as “the tip of the engaging part 162”). Before the engaging part 162 is engaged into the groove 121a, the protrusion 163 preferably extends in a direction inclined at 60° or larger and 120° or smaller with respect to the direction in which the engaging part 162 extends, i.e., the direction from the root of the engaging part 162 toward the bottom surface of the groove 121a. Alternatively, the protrusion 163 may extend in a direction inclined at 75° or larger and 105° or smaller with respect to the aforementioned direction, or may extend roughly vertically. The protrusion 163 is preferably formed by using an elastic body softer than the hard elastic body of which the engaging part 162 is formed. That is, the elastic body of which the protrusion 163 is formed has a smaller specific gravity and a smaller Shore A hardness than those of the hard elastic body of which the engaging part 162 is formed. The protrusion 163 may be formed by using the same material as that of the deformable cylindrical part 161, or may be formed by using a material different from that of the deformable cylindrical part 161.

As shown in FIG. 5, the protrusion 163 is crushed when the engaging part 162 is engaged into the groove 121a, and is sandwiched between the tip of the engaging part 162 and the side wall of the groove 121a. As the protrusion 163 is crushed as described above, the gap between the tip of the engaging part 162 and the side wall of the groove 121a is sealed, and the engaging part 162 is fixed in the groove 121a. Therefore, it is possible to prevent moisture from entering into the gap between the tip of the engaging part 162 and the side wall of the groove 121a, and prevent the engaging part 162 from being displaced after it is engaged into the groove.

A wall-like part 164 is preferably provided at the end of the root of the engaging part 162 on the side thereof close to the movable glass 120. The wall-like part 164 preferably extends in a direction inclined at 20° or larger and 110° or smaller with respect to the direction in which the engaging part 162 extends, may extend in a direction inclined at 45° or larger and 95° or smaller with respect thereto, or may extend in a direction inclined at 70° or larger and 90° or smaller with respect thereto. The wall-like part 164 is preferably formed by using the same hard elastic body as that of which the engaging part 162 is formed.

Before the engaging part 162 shown in FIG. 4 is engaged into the groove 121a, the distance between the wall-like part 164 and the protrusion 163 is preferably 1.5 mm or longer, and more preferably 2.0 mm or longer in order to make the manufacturing thereof easy. The thickness of the wall-like part 164 is preferably 1 mm or larger in order to ensure the rigidity of the wall-like part 164. Further, as shown in FIG. 5, the tip of the wall-like part 164 is preferably not in contact with any of other members in a state where the engaging part 162 is engaged into the groove 121a. The frame 121 includes a projection 121c that projects toward the fixed glass 110 and forms a part of the side wall of the groove 121a. For example, the distance between the tip of the wall-like part 164 and the projection 121c is preferably 0.3 mm or longer, and more preferably 0.5 mm or longer.

As shown in FIG. 5, the position of the upper end of the wall-like part 164 is higher than that of the upper end of the root of the engaging part 162. Therefore, by providing the wall-like part 164, it is possible to store a larger amount of moisture in the upper part of the deformable cylindrical part 161 as compared with the case where the wall-like part 164 is not provided.

As shown in FIG. 5, the contact part 165 is a part of the seal member 160 that comes into contact with the fixed glass 110 before any of the other parts thereof does when the small window 111 is closed, i.e., when the movable glass 120 is fitted into the small window 111. A center line 121b is an extension line of the center line of the groove 121a. The contact part 165 is preferably positioned on the center line 121b when it has not yet come into contact with the fixed glass 110. Note that the “positioned on the center line 121b” includes cases where the distance from the center line 121b to the contact part 165, i.e., the displacement of the contact part 165 with respect to the center line 121b, is within a predetermined range. The distance from the center line 121b to the contact part 165 is preferably 1 mm or shorter, and more preferably 0.5 mm or shorter. By making a design so that the contact part 165 is positioned on the center line 121b, it is possible to ensure a roughly uniform surface-pressure distribution of the seal member 160 over the fixed glass 110 during the sealing process. That is, it is possible to prevent the engaging part 162 from being displaced from the predetermined position in the groove 121a of the frame 121 during the process in which the seal member 160 receives a load from the fixed glass 110 and is thereby deformed.

Further, since the groove 121a of the frame 121 has rounded curved shapes at the corners of the small window 111, the seal member 160, which is fitted into the groove 121a, is also curved. The center line 121b is the neutral axis of the groove 121a. Therefore, by making a design so that the contact part 165 is positioned on the center line 121b, the contact part 165 can be maintained at the predetermined position without being affected by the compression or extension of the seal member 160 due to the curvature thereof.

As described above, in the window glass for vehicle 100, it is possible to prevent moisture from entering from the outside of the vehicle by using the seal member 160, i.e., to ensure sufficient watertightness. Further, the window glass for vehicle 100 has a simple structure as compared with a window glass for vehicle using a plurality of types of seal members, and hence its manufacturing cost can be reduced. Further, no friction, which would otherwise be caused as seal members are rubbed against each other, occurs, so that the resistance that is caused when the small window 111 is opened or closed is small. Further, as shown in FIG. 3, since the window glass for vehicle 100 has such a structure that the seal member 160 is concealed by the fixed glass 110 and hence is not seen from the outside of the vehicle, its design is excellent.

As shown in FIG. 3, in a state where the small window 111 is closed, a gap may be formed between the movable glass 120 and the fixed glass 110. Therefore, when it is rainy in a state where the small window 111 is closed, rainwater enters through the gap between the movable glass 120 and the fixed glass 110 and accumulates in the upper part of the deformable cylindrical part 161. When the small window 111 is opened in this state, the deformable cylindrical part 161, which has been deformed, is released, i.e., is restored to the original shape, so the accumulated rainwater falls on the support member 140 or the like. In order to drain the moisture that has fallen on the support member 140 to the outside of the vehicle, the window glass for vehicle 100 preferably includes drain covers 151, 152 and 153.

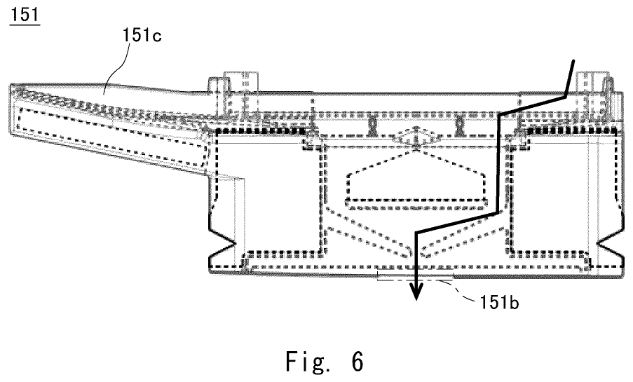

FIG. 6 shows an example of the drain cover 151. Among the three drain covers 151, 152 and 153, the drain cover 151 is attached to a part of the window glass for vehicle that is closest to the front of the vehicle. In the example shown in FIG. 2, the shape of the drain cover 151 is partially different from the those of the drain covers 152 and 153 because the drain cover 151 includes a slope 151c projecting toward the front of the vehicle on the side thereof on which the drain cover 151 is in contact with the support member 140. The slope 151c is provided to facilitate the drainage of moisture that has fallen on the drain cover 151 and thereby prevent the moisture from accumulating in the drain cover 151. However, the shapes of the drain covers 151, 152 and 153 are not limited to any particular shapes, and the drain cover 151 may have the same shape as those of the drain covers 152 and 153. The drain covers 151, 152 and 153 have functions substantially equivalent to each other.

An area 151a shown in FIG. 3 is an area to which an adhesive is applied. The drain cover 151 is fixed to the fixed glass 110 by the adhesive applied to the area 151a. A urethane adhesive is suitable as the aforementioned adhesive.

An area 151b shown in FIG. 6 is an area to which no adhesive is applied. An adhesive is applied to each of both right and left sides of a part of the drain cover 151 near the lower end thereof. Since no adhesive is applied to the central part of the drain cover 151 near the lower end thereof, a gap through which moisture can pass is formed there.

An arrow shown in FIG. 6 indicates the drainage path of moisture that has fallen on the support member 140. The moisture that has fallen on the support member 140 flows to an area below the slide door 20 through the drainage path by the gravity thereof. A drain hole (not shown) is provided below the slide door 20. The moisture that has flown to the area below the slide door 20 is drained to the outside of the vehicle through the drain hole. As described above, in the window glass for vehicle 100, it is possible to drain moisture such as rainwater that has fallen on the support member 140 to the outside of the vehicle.

Although the present disclosure has been described above with reference to the above-described embodiments, the present disclosure is not limited to the configurations of the above-described embodiments. Needless to say, the present disclosure includes various modifications, corrections, and combinations that can be made by a person skilled in the art within the scope of the claims.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A window glass for vehicle comprising:
a fixed glass with an opening formed therein configured to be fixed to a vehicle;
a movable glass configured to be fitted into the opening in the fixed glass;
a support member configured to slidably support the movable glass relative to the fixed glass; and
a seal member configured to seal a gap between a peripheral edge of the movable glass and a peripheral edge of the opening in the fixed glass when the movable glass is fitted into the opening in the fixed glass, wherein
a frame is provided on the peripheral edge of the movable glass,
the frame includes a groove into which the seal member is fitted,
the seal member includes a deformable cylindrical part deformable at the time of sealing, and an engaging part extending from the deformable cylindrical part toward a bottom surface of the groove,
the engaging part is formed by using a hard elastic body, and the deformable cylindrical part is formed by using a soft elastic body, and
a height of a mouth of the groove is larger than a thickness of a root of the engaging part.

2. The window glass for vehicle according to claim 1, wherein
the hard elastic body of which the engaging part is formed has a specific gravity of 0.7 or higher and 1.2 or lower, and has a Shore A hardness of 50 or higher and 90 or lower as measured according to JIS K 6253 (2012), and
the soft elastic body of which the deformable cylindrical part is formed has a specific gravity of 0.2 or higher and 0.7 or lower, and has a Shore A hardness of 20 or higher and 50 or lower as measured according to JIS K 6253 (2012).

3. The window glass for vehicle according to claim 1, wherein
a protrusion is provided at a tip of the engaging part in a direction in which the engaging part extends, the protrusion extending in a direction inclined at 60° or larger and 120° or smaller with respect to the direction in which the engaging part extends before the engaging part is engaged into the groove, and
the protrusion is formed by using an elastic body softer than the hard elastic body of which the engaging part is formed.

4. The window glass for vehicle according to claim 1, wherein
a wall-like part is provided on a movable-glass side of a boundary between the deformable cylindrical part and the engaging part, the wall-like part extending in a direction inclined at 20° or larger and 110° or smaller with respect to the direction in which the engaging part extends, and
the wall-like part is formed by using the same hard elastic body as that of which the engaging part is formed.

5. The window glass for vehicle according to claim 4, wherein
a protrusion is provided at a tip of the engaging part in a direction in which the engaging part extends, the protrusion extending in a direction inclined at 60° or larger and 120° or smaller with respect to the direction in which the engaging part extends before the engaging part is engaged into the groove,
the protrusion is formed by using an elastic body softer than the hard elastic body of which the engaging part is formed, and
a distance between the wall-like part and the protrusion is 1.5 mm or longer before the engaging part is engaged into the groove.

6. The window glass for vehicle according to claim 4, wherein
the frame includes a protrusion protruding toward the fixed glass and forming a part of a side wall of the groove, and
a distance between a tip of the wall-like part and the protrusion is 0.3 mm or longer when the engaging part is engaged into the groove.

7. The window glass for vehicle according to claim 1, wherein
the seal member includes a contact part, the contact part being a part that comes into contact with the fixed glass before any of other parts thereof does when the movable glass is fitted into the opening in the fixed glass, and
the contact part is positioned on an extension line of a center line of the groove.

8. The window glass for vehicle according to claim 1, further comprising a drain cover attached to a lower part of the support member, wherein
moisture accumulated in the seal member in a state where the movable glass is fitted into the opening in the fixed glass is drained to outside of the vehicle through the frame and the drain cover when the movable glass is displaced from the opening in the fixed glass.
